(19) United States
(12) Patent Application Publication
(10) Pub. No.: US 2010/0328719 A1
(43) Pub. Date: Dec. 30, 2010

(54) SYSTEM AND METHOD FOR SUSTAINABLE PRINTING

(76) Inventor: Joseph Tholl Miller, West Bloomfield, MI (US)

Correspondence Address: FRASER CLEMENS MARTIN & MILLER LLC, 28366 KENSINGTON LANE, PERRYSBURG, OH, 43551, US

(21) Appl. No.: 12/822,776

(22) Filed: Jun. 24, 2010

Related U.S. Application Data
(60) Provisional application No. 61/269,511, filed on Jun. 25, 2009.
(60) Provisional application No. 61/270,917, filed on Jul. 15, 2009.
(60) Provisional application No. 61/336,475, filed on Jan. 25, 2010.

(51) Int. Cl. G06F 15/00

(52) U.S. Cl. 358/1.15

(57) ABSTRACT

A sustainable printing system includes an advertisement record having an information relating to a printable advertisement, a user record having information relating to a particular user, a printer for generating a visual output on a paper, a user interface in communication with the printer, the user interface including a processor for configuring the visual output generated by the printer in response to a comparison between the advertisement record and the user record.

### CROSS-REFERENCE TO RELATED APPLICATIONS

The present application claims priority to U.S. Provisional Application Ser. No. 61/269,511 filed Jun. 25, 2009, U.S. Provisional Application Ser. No. 61/270,917 filed Jul. 15, 2009, and U.S. Provisional Application Ser. No. 61/336,475 filed Jan. 25, 2010, each of which are hereby incorporated herein by reference in its entirety.

### FIELD OF THE INVENTION

The present invention relates generally to paper printing. In particular, the invention is directed to a system and method for sustainable printing.

### BACKGROUND OF THE INVENTION

World energy consumption is projected to increase by 50 percent from 2005 to 2030. In the absence of national policies and/or binding international agreements that would limit or reduce greenhouse gas emissions, world carbon dioxide emissions are estimated to continue to increase steadily from 28.1 billion metric tons in 2005 to 34.3 billion metric tons in 2015 and 42.3 billion metric tons in 2030—an increase of 51 percent over the projection period. Already the average temperature of the last 15 years has been the highest ever recorded and the ice cap is 40% thinner than it was 40 years ago. And while all this is happening, every year 13 million hectares of forest disappear.

It would be desirable to develop a system and method for sustainable printing to provide a means for carbon offset.

### SUMMARY OF THE INVENTION

Concordant and consistent with the present invention, a system and method for sustainable printing to provide a means for carbon offset, has surprisingly been discovered.

In one embodiment, a sustainable printing system comprises: an advertisement record having an information relating to a printable advertisement; a user record having information relating to a particular user; a printer for generating a visual output on a paper; a user interface in communication with the printer, the user interface including a processor for configuring the visual output generated by the printer in response to a comparison between the advertisement record and the user record.

The invention also provides methods for sustainable printing.

One method comprises the steps of: storing a plurality of advertisement records on a database, each of the advertisement records including an information relating to a printable advertisement; providing a user interface in communication with a printer and the database; storing a user record on at least one of the database and the user interface, the user record having information relating to a particular user; initiating a print command on the user interface; comparing the advertisement record and the user record based upon a pre-defined instruction set to define a target one of the printable advertisements; and causing the printer to generate a visual output on a paper, the visual output selectively including the target one of the printable advertisements.

Another method comprises the steps of: storing a plurality of advertisement records on a database, each of the advertisement records including an information relating to a printable advertisement; providing a user interface in communication with a printer and the database; initiating a print command on the user interface; generating a user record having information relating to a location of the user interface at the time the print command is initiated; comparing the advertisement record and the user record based upon a pre-defined instructions set to define a target one of the printable advertisements; and causing the printer to generate a visual output on a paper, the visual output selectively including the target one of the printable advertisements.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a schematic block diagram of a sustainable printing system according to an embodiment of the present invention;

FIG. 2 is a schematic flow diagram of a method for registering a advertiser according to an embodiment of the present invention;

FIG. 3 is a schematic flow diagram of a method for registering a user according to an embodiment of the present invention; and

FIG. 4 is a schematic flow diagram of a method for sustainable printing using the printing system of FIG. 1.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

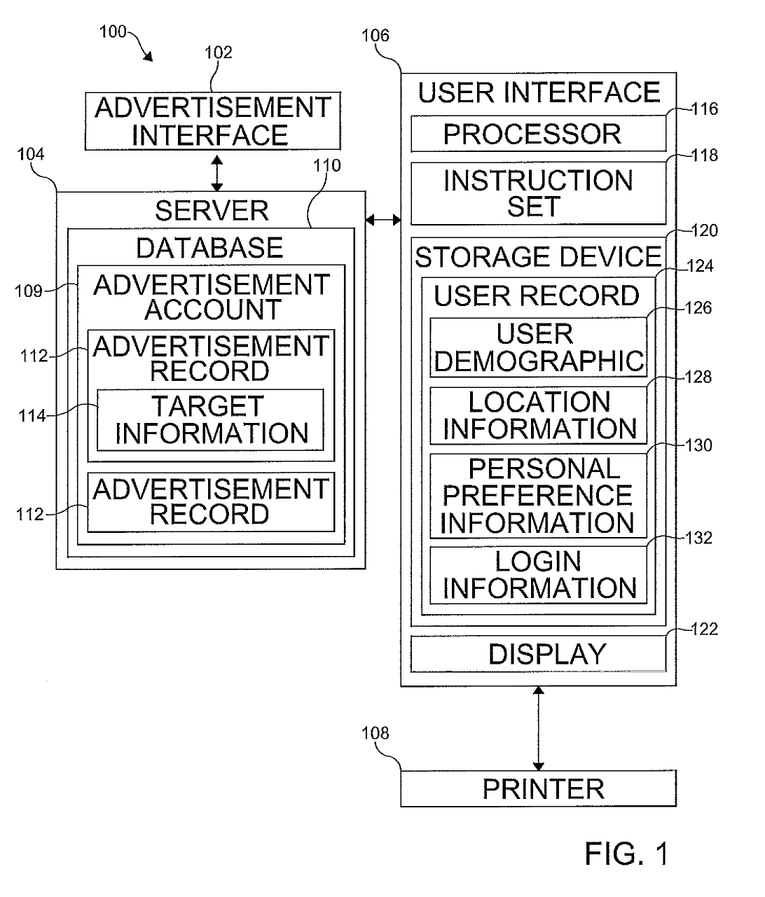

Referring to FIG. 1, there is illustrated a sustainable printing system 100 according to an embodiment of the present invention. As shown, the system 100 includes an advertisement interface 102, a server 104, a user interface 106, and a printer 108. It is understood that the system 100 can include any number of components.

The advertisement interface 102 is typically a computer in communication with the server 104. The advertisement interface 102 provides a means for a potential advertiser to establish an advertisement account 109 to catalog and store printable advertisements on the server 104 for selective placement and distribution by the system 100. It is understood that various electronic devices can be used to provide intercommunication between the advertiser and the server 104.

The server 104 is in communication with the advertisement interface 102 and the user interface 106. The server 104 is adapted to manage data stored in a database 110 and interconnections between the database 110 and various resources not stored in the database 110. The server 104 may also be adapted to perform operations such as, a data query, a data transfer, a data retrieval, and a data processing, for example. As a non-limiting example, the database 110 is a Structured Query Language (SQL) database adapted to be searched and queried by the user interface 106. However, other languages and protocols may be used for processor-database compatibility. It is understood that other devices may be used to manage the data stored in the database 110 such as a software engine and a software package, for example. It is further understood that the database 110 can store information relating to a number of the advertisement accounts 109.

As shown, the advertisement accounts 109 include at least one advertisement record 112 associated with a particular printable advertisement. For example, each of the advertisement records 112 includes a contact information (i.e. an identification data for an associated advertiser) and an advertisement information (i.e. the words, symbols, logos, trademarks, and other printable graphics) intended to be published in the printable advertisement. As a non-limiting example, at least one of the records 112 includes a pre-defined target information 114 associated with a particular one of the printable advertisements, wherein the target information 114 defines a set of characteristics of an intended viewer (i.e. audience) of the printable advertisement. It is understood that the advertiser can provide any set of target characteristics (e.g. demographics) to define any intended or “targeted” audience as is known in the marketing and advertisement industry.

In certain embodiments, the advertisement records 112 are converted into a proprietary standardized and normalized database table or set of tables and indices against which the user interface 106 can be coded to search. It is understood that a cumulative library of normalizing scripts can be included to provide a means for the creation of mailing lists from disparate incoming files.

The user interface 106 is in communication with the server 104 and the printer 108 and adapted to intercommunicate therewith. As a non-limiting example, the user interface 106 is a personal computer. However, other electronics devices can be used. As a further non-limiting example, the user interface 106 is integrated with the printer 108. It is understood that the user interface 106 can communicate with the server 104 and the printer 108 through various communication means such as hardwire and wireless devices. It is further understood that various electronic devices can be used to provide intercommunication between the user and the server 104.

As shown, the user interface 106 includes a processor 116, an instruction set 118, a storage device 120, and a display 122. However, the user interface 106 can include any number of components.

The processor 116 may be any device or system adapted to configure the printer 108 to print a pre-determined visual output. In certain embodiments, the processor 116 transmits a source data to the printer representing an output to be printed on paper. As a non-limiting example, the processor 116 is adapted to query the database 110 and configure the printer 108 based upon the query results. As a further non-limiting example, the processor 116 performs operations (e.g. query the database 110, configure the printer 108) based on the instruction set 118.

The instruction set 118, which may be embodied within any computer readable medium, includes processor executable instructions for configuring the processor 116 to perform a variety of tasks. As a non-limiting example, the instruction set 118 includes a software code to query the database 110, compare data, and configure the printer 108 to generate a visual output. As a further non-limiting example, the instruction set 118 can be hosted on the Internet and downloaded to the user interface 106. However, it is understood that the instruction set 118 can be hosted remotely from the user interface 106 such as a web application, for example. In certain embodiments, the instruction set 118 is embodied as a binary executable software that is launched at a start-up of an operating system of the user interface 106.

The storage device 120 may be a single storage device or may be multiple storage devices. Furthermore, the storage device 120 may be a solid state storage system, a magnetic storage system, an optical storage system or any other suitable storage system or device. It is understood that the storage device 120 is adapted to store the instruction set 118. In certain embodiments, the storage device 120 stores a user record 124 including at least one of a contact information (i.e. an identification data for an associated user), a personal information relating to demographic characteristics (i.e. user demographic 126), a location information 128 representing a global position of at least one of the user and the user interface 106, a set of personal preferences 130 or interests, and a login information 132 (i.e. credentials) to provide secured and selective access to the user record 124. Other data and information may be stored in the storage device 120, as desired. As a non-limiting example, the user record 124 for each of a plurality of registered users can be stored on the database 110 and accessed by the user interface 106 through hardwire or wireless communication means.

The display 122 can be any means for generating a visual output to a user such as a liquid crystal display, for example. In certain embodiments, the display 122 is a touch screen with user-engageable buttons to control the operation of the user interface 106. In certain embodiments, the display 122 is integrated with the printer 108.

The printer 108 is in communication with the user interface 106 to generate a visual output in printed form (e.g. on paper). In certain embodiments, the user interface 106 is integrated with the printer 108 such as a commercial-grade printer found in a university or business environment. In certain embodiments, the printer 108 is a stand-alone printer in communication with the user interface 106 through hardwire or wireless communication means.

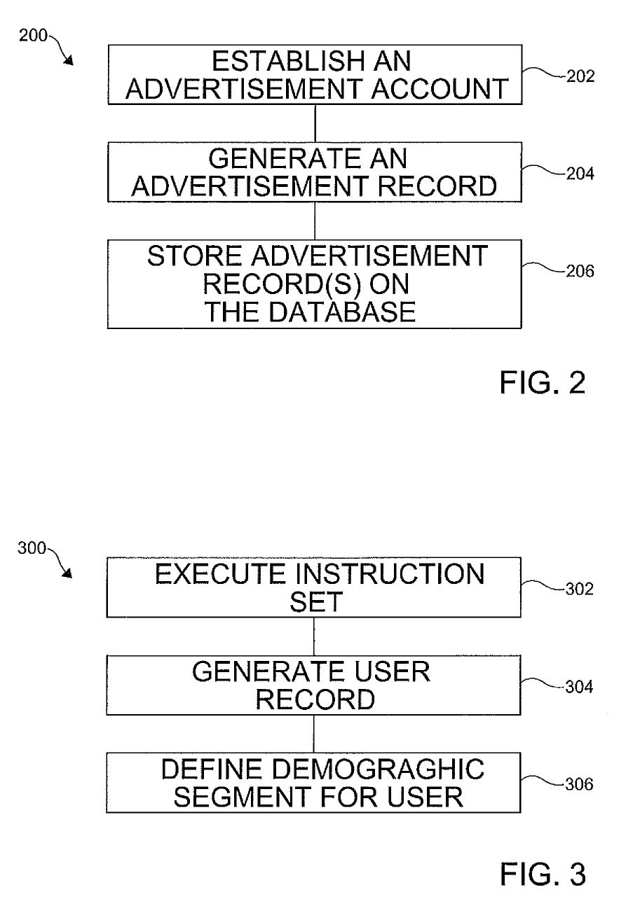

FIG. 2 illustrates a method for registering a potential advertiser, indicated generally at 200. In step 202, an advertiser establishes one of the advertisement accounts 109 by accessing the server 104 through the advertisement interface 102. The step of establishing the advertisement account 109 can include providing contact information, billing information, and consenting to an agreement of terms and conditions of a sustainability project such as Print-A-Forest described at www.printaforest.com. In step 204, the advertiser generates one of the advertisement records 112 by providing information relating to a printable advertisement including a set of characteristics that define the target information 112 associated with the printable advertisement. In step 206, the advertisement record 112 is stored in the database 110 for selective distribution and printing.

FIG. 3 illustrates a method for registering a potential user, indicated generally at 300. In step 302, the user executes the instruction set 118 to allow real-time monitoring of any print commands initiated through the user interface 106. In step 304, the processor 116 generates one of the user records 124 based upon at least one of a user-provided contact information (i.e. an identification data for an associated user), the user demographic 126, the location information 128 (e.g. determined by a positioning device (not shown) or internet protocol address associated with the user interface 106), the set of personal preferences 130 or interests, and the log-in information 132 (i.e. credentials). In certain embodiments, the instruction set 118 prompts the user to provide feedback (e.g. the set of personal preferences 130) relating to a survey of personal interests and preference. If is understood that the survey can include any questions or data collection means. In step 306, the processor 116 defines a demographic segment associated with the particular user based upon at least one of the user-provided contact information (i.e. an identification data for an associated user), the user demographic 126, the location information 128, and the set of personal preferences 130 or interests. As a non-limiting example, the demographic segment is a pre-defined categorization of various combinations of demographic characteristics and personal preferences.

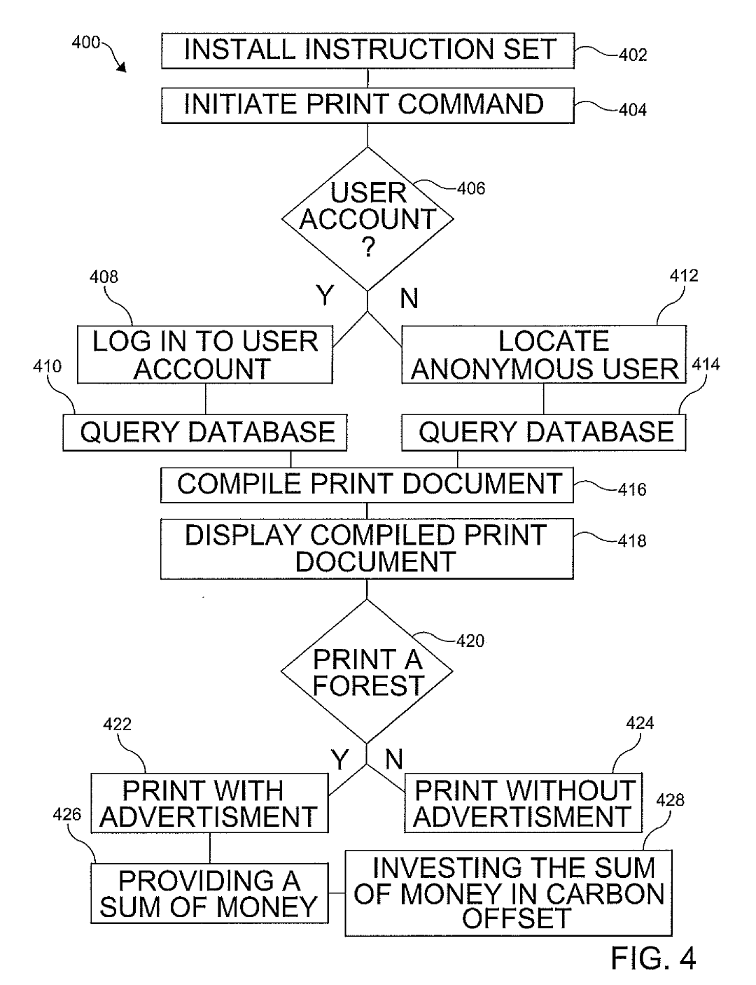

FIG. 4 illustrates a method for sustainable printing according to an embodiment of the present invention, indicated generally at 400. In step 402, a user installs the instruction set 118 on the user interface 106. During normal operation of the user interface 106, the user can initiate a print command, as shown in step 404. In a conventional system, the print command causes a source data to be transmitted to the printer 108 for a subsequent printing operation. In the present invention, the step of initiating the print command causes the processor 116 to prompt the user for login credentials associated with a particular one of the user records 124, as shown in step 406.

In certain embodiments, while the instruction set 118 is resident in a memory of the user interface 106, the processor 116 monitors any print commands and queued print jobs sent to the printer 108 while the user has permissions to access the printer 108. The processor 116 intercepts data sent to be printed, presenting the user with a visual prompt consisting of questions and options, prior to allowing the document to be printed to physical paper. Upon receiving an intercepted data, the processor 116, presents a “Wizard” type prompt, consisting of typical “Back”, “Next” buttons, guiding the user through a series of questions and options.

If the user is a registered user with a pre-established one of the user records 124, the method continues to step 408. If the user is an unregistered user (i.e. anonymous user) and is not associated with one of the user records 124, the method continues to step 412. In certain embodiments, an unregistered user can be prompted to register by following the steps illustrated in FIG. 3.

In step 408, the user provides the appropriate login information 132 to access an associated one of the user records 124. Once the user record 124 is accessed, the processor 116 performs a query at step 410 on the database 110 to selectively identify one of the advertisement records 112 that is “targeted” to the particular user or environment of the user. For example, at least one of the user demographic 126, the location information 128, and the personal preference information 130 is matched to the target information 114 of one of the advertisement records 112 based upon criteria defined by the instruction set 118. It is understood that a default one of the advertisement records 112 can be selected based upon a pre-defined characteristic of the user record 124. Once one of the advertisement records 112 is selected the method continues to step 416.

In step 412, the user interface 106 is located. For example, an internet protocol address of the user interface 106 can be used to define a regional position of the user interface 106 at the time the print command was initiated. As a further example, the user interface 106 may include a global positioning device (not shown) to identify and communicate a location of the user interface 106 to the processor 106.

Once the user interface 106 is located, the processor 116 performs a query on the database 110 to selectively identify one of the advertisement records 112 that is “targeted” to the particular location of the user interface 106, as shown in step 414. For example, one of the advertisement records 112 may include a target information 114 directed to a particular region of the world. Once one of the advertisement records 112 is selected the method continues to step 416.

In step 416, the printable advertisement associated with the target one of the advertisement records 112 is compiled with the source data to generate a print document. As a non-limiting example, the printable advertisement is disposed in a margin of the paper while the source data is disposed in a standard “print region” of the paper.

In step 418, an image of the print document is presented on the display 122. It is understood that the user can request a print preview of the print document illustrating the print document with or without the printable advertisement disposed thereon.

In step 420, the user is prompted to selectively print the requested document including the target advertisement. As a non-limiting example, the user is prompted to selectively participate in the Print-A-Forest program. If the user selects “YES”, the print document is generated including the target advertisement in step 422. If the user selected “NO”, the print document is generated without the target advertisement in step 424.

In step 426, each of the advertisers provides a sum of money based upon a number of associated printable advertisements that are generated by the printer 108. It is understood that the system 100 can track information related to the location and frequency of each of the printable advertisements that are generated.

In step 428, at least a portion of the monies provided by the advertisers is invested in carbon offset. As a non-limiting example, the term carbon offset is meant to explain the process of participating in a positive activity for the environment which includes but is not restricted to reforestation, forest preservation, research grants, and investment in renewable energy, in order to offset the negative toll on the environment caused by printing.

In certain embodiments, at least one of the server 104 and user interface 106 can track a total of all monies invested in a carbon offset program based upon the printing of advertisements using the system 100. As a non-limiting example, the display 122 can generate a visual output representing the number of trees that have been planted with monies resulting from use of the system 100 and method 400.

By adding a printing option for environmentally sustainable printing, users of the system 100 are given a choice to have environmentally friendly printing. The system 100 inserts margin advertisements or advertisements on an unused back side of the printed page with at least a portion of the proceeds from the advertisement pooled into an equity fund for the purpose of providing a carbon offset (e.g. reforestation).

The system 100 and method 400 provide individuals a choice to change the printing of paper from a negative toll on the environment, using energy and causing deforestation, to a positive force committed to eliminating our dependence of fossil fuels and the reforestation of our planet.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A sustainable printing system comprising:
an advertisement record having an information relating to a printable advertisement;
a user record having information relating to a particular user;
a printer for generating a visual output on a paper;
a user interface in communication with the printer, the user interface including a processor for configuring the visual output generated by the printer in response to a comparison between the advertisement record and the user record.

2. The printing system according to claim 1, wherein the advertisement record includes a characteristic of a target audience.

3. The printing system according to claim 1, wherein the user interface is integrated with the printer.

4. The printing system according to claim 1, wherein an operation of the processor is based upon a pre-defined instruction set.

5. The printing system according to claim 4, wherein the instruction set is a software application executed during a start-up of an operating system of the user interface.

6. The printing system according to claim 1, wherein the user record includes at least one of a pre-defined user demographic, a global position of the user, a personal preference information, and a login information.

7. The printing system according to claim 1, wherein the visual output generated by the printer includes the printable advertisement.

8. A method for sustainable printing comprising the steps of:
storing a plurality of advertisement records on a database, each of the advertisement records including an information relating to a printable advertisement;
providing a user interface in communication with a printer and the database;
storing a user record on at least one of the database and the user interface, the user record having information relating to a particular user;
initiating a print command on the user interface;
comparing the advertisement record and the user record based upon a pre-defined instruction set to define a target one of the printable advertisements; and
causing the printer to generate a visual output on a paper, the visual output selectively including the target one of the printable advertisements.

9. The method according to claim 8, wherein the advertisement record includes a characteristic of a target audience.

10. The method according to claim 8, wherein the user record includes at least one of a pre-defined user demographic, a global position of the user, a personal preference information, and a login information.

11. The method according to claim 8, wherein the target one of the printable advertisements is disposed in a margin of the paper.

12. The method according to claim 8, wherein the target one of the printable advertisements is disposed on an unused side of the paper.

13. The method according to claim 8, further comprising the steps of:
providing a sum of money based upon the printing of the target one of the printable advertisements; and
investing at least a portion of the sum of money in carbon offset.

14. A method for sustainable printing comprising the steps of:
storing a plurality of advertisement records on a database, each of the advertisement records including an information relating to a printable advertisement;
providing a user interface in communication with a printer and the database;
initiating a print command on the user interface;
generating a user record having information relating to a location of the user interface at the time the print command is initiated;
comparing the advertisement record and the user record based upon a pre-defined instructions set to define a target one of the printable advertisements; and
causing the printer to generate a visual output on a paper, the visual output selectively including the target one of the printable advertisements.

15. The method according to claim 14, wherein the advertisement record includes a demographic characteristic of a target audience.

16. The method according to claim 14, wherein the user record includes at least one of a pre-defined user demographic, a global position of the user, a personal preference information, and a log-in information.

17. The method according to claim 14, wherein the location of the user interface is determined based upon an internet protocol address associated therewith.

18. The method according to claim 14, wherein the target one of the printable advertisements is disposed in a margin of the paper.

19. The method according to claim 14, wherein the target one of the printable advertisements is disposed on an unused side of the paper.

20. The method according to claim 14, further comprising the steps of:
providing a sum of money based upon the printing of the target one of the printable advertisements; and
investing at least a portion of the sum of money in carbon offset.
